(19) United States
(12) Patent Application Publication
(10) Pub. No.: US 2009/0021398 A1
(43) Pub. Date: Jan. 22, 2009

(54) GANG TRACKER

(75) Inventor: Jerry Thompson, Boise, ID (US)

Correspondence Address: PERKINS COIE LLP;PATENT-SEA, P.O. BOX 1247, SEATTLE, WA, 98111-1247, US

(73) Assignee: Sky Detective, Inc., Eagle, ID (US)

(21) Appl. No.: 12/175,253

(22) Filed: Jul. 17, 2008

Related U.S. Application Data
(60) Provisional application No. 60/950,510, filed on Jul. 18, 2007.

(51) Int. Cl. G08B 23/00

(52) U.S. Cl. 340/990; 340/573.4

(57) ABSTRACT

Systems and methods (“the system”) for preventing gang-related activity are described. In various embodiments, the system receives an indication of a correspondence between a person and a tracking device, the person being a known member of a gang; receives an indication of a correspondence between the gang member and a geographic area; stores the received indications in a storage; tracks a geographic location of the gang member wherein the tracking includes receiving an electronic signal from the tracking device indicating the geographic location; determines a position of the geographic location with respect to the geographic area; and if the position of the geographic location with respect to the geographic area violates a rule, sends an alert.

### CROSS-REFERENCE TO RELATED APPLICATION(S)

This patent application claims the benefit of U.S. Provisional Patent Application Ser. No. 60/950,510, filed on Jul. 18, 2007, entitled “Gang Tracker,” which is incorporated herein by reference in its entirety.

### BACKGROUND

Various cities in the United States and elsewhere are afflicted by gangs. A gang is an ongoing organization, association, or group of individuals, whether formal or informal. A gang member is an individual who forms an affinity with a gang and who may participate in a pattern of criminal activity. Most gang members are proud of their gang and freely admit their membership. Many may have tattoos and dress in a style identifying their particular gang. Their personal property is frequently covered with graffiti, the gang's logo, and the member's gang name. Gang members can be characterized by which gang they belong to. A gang typically will associate itself with a geographic area (‘turf’) and may battle with other gangs to protect or enlarge its turf. The gang may then engage in criminal activity within its turf, such as racketeering, drug sales or use, vandalism, robbery, and so forth. It is thus in society's interests to prevent the proliferation of gangs.

### BRIEF DESCRIPTION OF THE DRAWINGS

FIG. 1 is a block diagram illustrating components of the system in various embodiments.

FIG. 2 is a map diagram illustrating gangs and turfs.

FIGS. 3-4 are flow diagrams illustrating routines invoked by the system in various embodiments.

FIG. 5 is a block diagram illustrating components of the system in various embodiments.

### DETAILED DESCRIPTION

Methods and systems (“the system”) is described for effective prevention, intervention and suppression of serious gang activities through use of the services of a private company (“monitoring company”) working with law enforcement agencies. These agencies include police, probation, parole and community organizations. The system can be utilized in conjunction with court orders and would be part of a court ordered supervision or parole period of individuals, such as gang members.

Gang area zoning is a technique for zoning specific known and targeted gang areas and enables a private company to monitor and track high-risk gang members within the area. Global Positioning Satellite (“GPS”) receiving units are attached to individual gang members by order of a court of law as a condition of the members' probation or parole. The GPS units can emit a signal identifying the units' position and other status information at all times. The gang member's location, direction of travel, and speed can thereby be monitored around the clock.

If a GPS unit enters a designated area, leaves a designated area, or violates some other location-related rule of the gang member's release or parole, the private company's monitoring system can detect this activity and alert an appropriate officer or agent of the agency designated to work with the gang member. The violation of the rule can constitute a violation of the gang member's court ordered probation or parole condition. As an example, the monitoring system may issue a notification to the appropriate law enforcement agency, such as a police department or juvenile enforcement agency. The law enforcement agency can then easily identify the present location of the gang member and apprehend the gang member.

The GPS unit could be located in a bracelet, such as an ankle bracelet,wrist bracelet, leg bracelet, arm bracelet, or other device that can be attached to a person. Another device could be attached to the gang member's vehicle. Either of these devices have the capability of sending an alert to the private monitoring company, such as via a mobile telephone signal. Use of these technologies may confine a gang member to a specified geographical area. The system can employ GPS or other location detection technologies, such as CDMA, GSM, Wi-Fi, Bluetooth, or even a network of cooperating mobile devices that can calculate their location based on relaying data from one mobile device to another and then relay a signal to a known, fixed location. The latter system is called Link Net. With Link Net, the ability to track vehicles is added to each of the gang tracking technologies described. Each car and/or vehicle has a repeater chip built into it, thus a device in any location can use the repeater in these vehicles and/or other deployed repeaters to send and transmit data to and from known fixed locations.

Tracking a gang member's movement is a very real deterrent in preventing known gang members from becoming mobile to engage in crimes, such as crimes with their gangs or against other gangs.

The zoning of rival gang areas provides additional security coverage to the gang area zoning techniques described above. Rival gang area zoning enables tracking of a specific gang member who violates a zone rule and travels into a rival gang area. Tracking this movement provides law enforcement with a record of the gang member's exact whereabouts in the event a crime occurs between two rival gangs. Because the gang member can be electronically identified as having been in the rival gang's area when the crime occurred, law enforcement officers would not need an eye witness because data can be used to establish that the monitored individual was at the exact same place at the exact same time as a crime, such as a drive-by shooting.

To establish rival gang area zoning, the monitoring company in conjunction with law enforcement creates pre-established zones specific to each court case or gang member. GPS units are attached to specific gang members to accomplish this system of monitoring. Rival gang areas can be established and locations where narcotics are known to be commonly distributed or used can be identified. An individual can be prohibited by a court from contacting a rival gang or entering its zone by a rule. When the monitoring system detects that the individual has entered the zone or is near the zone, the monitoring system may issue a notification to appropriate law enforcement agencies.

A high risk gang member can be identified and ordered by a court to wear a tracking device. This gang member is then assigned a monitor, such as an employee of a private monitoring company. The monitor would report to police, parole, probation, judge, prosecutor, or all of the above. The monitor can gather intelligence regarding the gang and the gang member, established zones or areas the gang member must be contained in and/or cannot enter (inclusion and exclusion zones), and provide the information to appropriate law enforcement agencies. A court can then define a rule (e.g., identifying what geographical areas the gang member cannot enter or leave). When the monitor determines that the gang member has violated the rule, the monitor can alert an appropriate law enforcement agency. Rules can also apply relating to other gang members the gang member associates with who are wearing a similar monitoring device. Zones can be established for each gang member to prevent these gang members from associating with each other.

If a gang member violates a rule, the monitor is notified in real time and a response (e.g., to alert a law enforcement agency) can be initiated. The rules can be enforced by court order, parole and/or probation and can be determined or identified before a gang member is monitored. A violation of these rules then becomes a violation of the terms of release or parole, and the gang member can be immediately subject to arrest. Because the location of the gang member is known, the gang member can be quickly located and arrested by a law enforcement officer.

The gang member may be under an order to charge the bracelet or monitoring device for a pre-set length of time, such as every night. The system can monitor the charging schedule and if the charging schedule is not followed, the gang member may be subject to arrest. The bracelet may not need to be removed for charging. The bracelet (or other monitoring/tracking device) can include a power supply, such as a rechargeable battery, that may need regular charging.

The system also enables tracking the geographical location of gang members. The system can collect and store records of areas that specific gang members have traveled to in order to further their criminal enterprise and engage in criminal activity. For example, when a crime has been committed, the system can determine whether any tracked gang members were in the area or location of the crime at the time of the crime.

The system can also function to track stalkers, sex offenders, victims and family members, and so forth. The system can be employed anywhere zoning for inclusion or exclusion is needed for restraining order enforcement, home detention, injunction, enforcement, public safety, and so forth.

Several embodiments of the facility are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement the importance system. In addition, the data structures and message structures may be stored or transmitted via a data transmission medium, such as a signal on a communications link. Various communications links may be used, such as the Internet, a local area network, a wide area network, or a point-to-point dial-up connection.

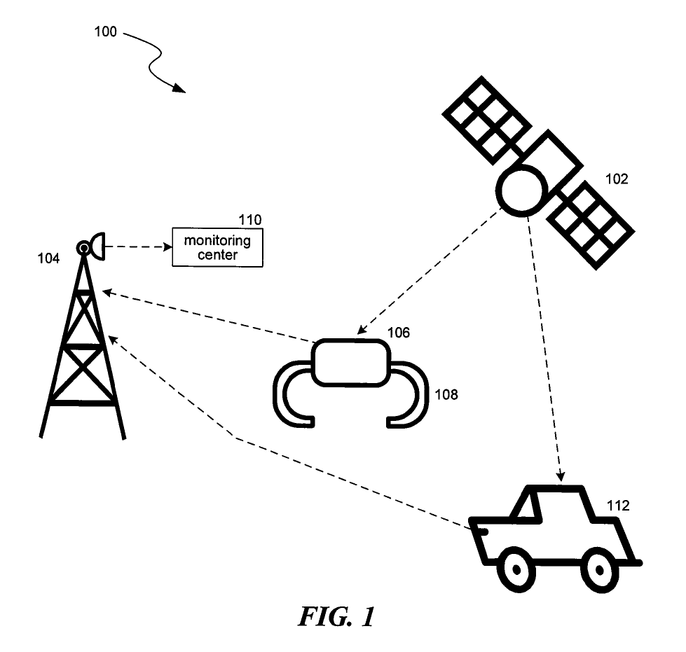

FIG. 1 is a block diagram illustrating components of the system in various embodiments. The system 100 can include a satellite 102, ground-based communications tower 104, monitoring device 108 having coupled thereto satellite signal receiver 106, monitoring center 110, and automobile 112. The satellite 102 may be one satellite in a network of satellites that each sends signals to the satellite signal receiver 106. Automobile 112 may also have a similar satellite signal receiver. The satellite signal receivers 106 receives signals from satellites 102 and determine a geographical location where the satellite signal receiver is presently located. Monitoring device 108 may be a bracelet, such as an ankle bracelet or a wrist bracelet. In various embodiments, the monitoring device may be attached to a person's ankle or wrist by court order. Upon receiving satellite signals, the monitoring device or the automobile can report the location that is determined based on the satellite signal to the monitoring center 110 via a communications tower 104. As examples, the monitoring device or automobile can make a mobile telephone call to a server located at the monitoring center 110. The monitoring device or automobile may also provide other status information, such as when the device was last charged, whether it has been tampered with, and so forth.

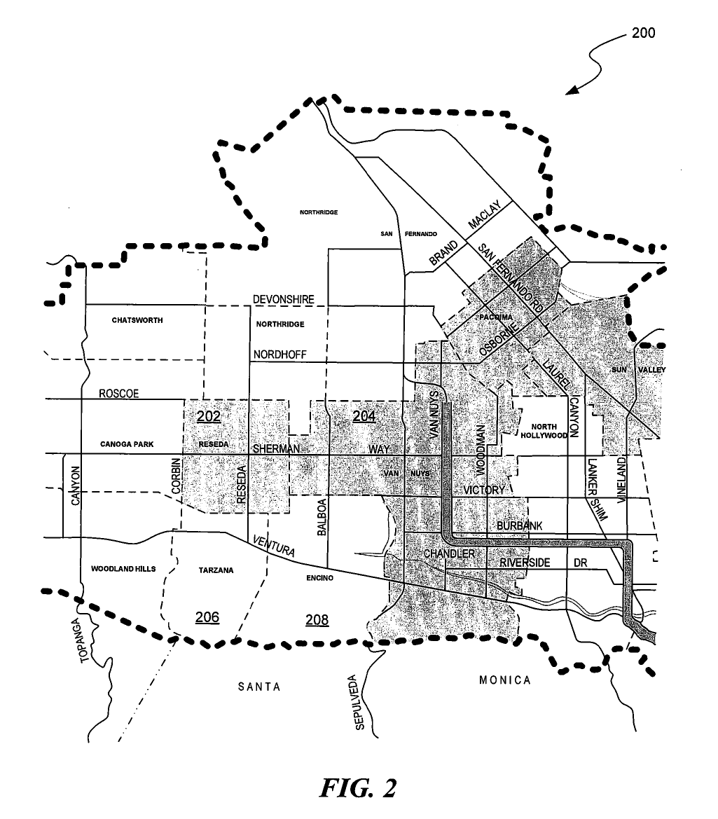

FIG. 2 is a map diagram illustrating gangs and areas or zones. The map 200 includes zones 202, 204, 206, and 208. In some embodiments, a computer located at the monitoring center may visually display a map, the zones, and the positions of devices that are being monitored. As an example, zones 202, 204, 206, and 208 may each be areas corresponding to different gangs. When a member of the gang corresponding to area 202 enters area 204, the system may provide a visual notification to the operator, send a signal to a monitor, and alert law enforcement agencies.

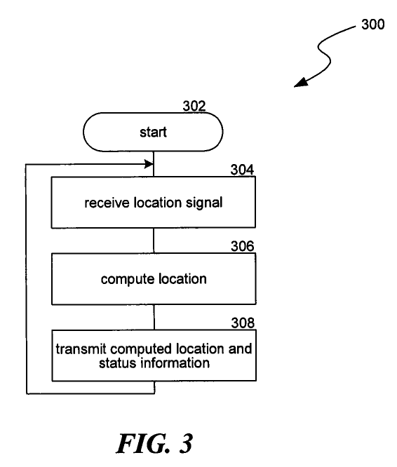

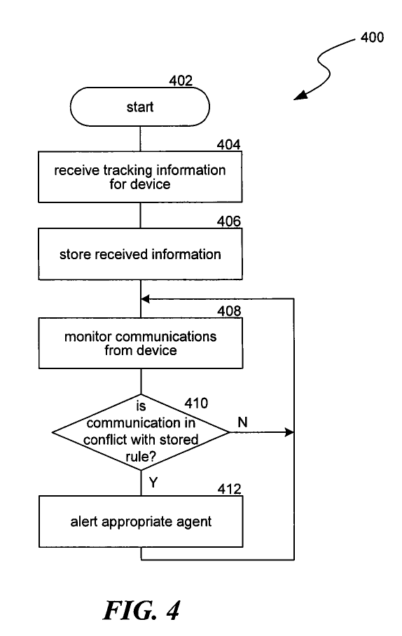

FIGS. 3-4 are flow diagrams illustrating routines invoked by the system in various embodiments.

FIG. 3 is a flow diagram illustrating a routine that may be invoked by a monitoring device. The routine 300 begins at block 302. At block 304, the routine receives a location signal. As an example, the routine may receive a GPS signal. At block 306, the routine computes a location based on the received signal. At block 308, the routine transmits the computed location information, such as via a mobile telephone link or other wireless communications technologies. The routine may also transmit status information, such as when the monitoring device was last charged and whether it has been tampered with.

Those skilled in the art will appreciate that the logic illustrated in FIG. 3 and described above, and in each of the flow diagrams discussed below, may be altered in a variety of ways. For example, the order of the logic may be rearranged, substeps may be performed in parallel, illustrated logic may be omitted, other logic may be included, etc.

FIG. 4 is a flow diagram illustrating a routine performed by a server computing device located at the monitoring center. The routine 400 begins at block 402. At block 404, the routine receives tracking information for the device. As an example, the routine may receive rules pertaining to whether the device can leave a specified geographical area, enter a specified geographical area, approach another monitoring device, and so forth. At block 406, the routine stores the received information. At block 408, the routine monitors communications from the specified device. In various embodiments, the routine may monitor communications from multiple monitoring devices. At decision block 410, the routine determines whether there is a conflict with the stored rule. As examples, complex may arise when the location of the monitoring device enters or leaves a geographical area that a rule indicates that the monitoring device should not enter or leave. If there is a conflict, the routine continues at block 412. Otherwise, the routine continues at block 408. At block 412, the routine alerts an appropriate agent. As examples, the routine may alert the operator of the computing device, the monitor of the individual who is being monitored, a law enforcement agent, and so forth.

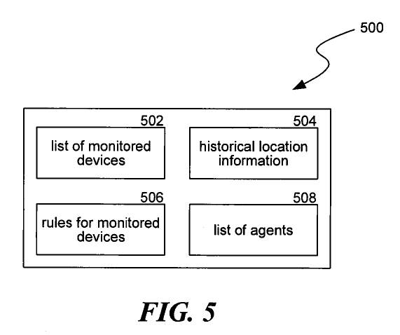

FIG. 5 is a block diagram illustrating components of the system in various embodiments. The system 500 can include a list of monitored devices 502, a storage of historical location information for one or more monitored devices 504, rules for the monitored devices 506, and a list of agents who should be alerted when a rule is violated 508.

In various embodiments, the system enables law enforcement agencies to enforce gang injunctions. When a court issues a gang injunction, law enforcement officer can put a member of that gang in jail if the gang member is found to be congregating, loitering, trespassing, intimidating residents, or possessing weapons, drugs, or tools for graffiti. The injunction can also establish a curfew that prohibits gang members from entering school safety zones, being outside the member's home after a specified time, and so forth. The system can store these rules, track whether a gang member violates a rule, and provide relevant notification to appropriate law enforcement agencies. The system can infer rules it uses to determine whether to send an alert based on court injunctions or other court orders.

In various embodiments, the system receives an indication of a correspondence between a person and a tracking device, the person being a known member of a gang; receives an indication of a correspondence between the gang member and a geographic area; stores the received indications in a storage; tracks a geographic location of the gang member wherein the tracking includes receiving an electronic signal from the tracking device indicating the geographic location; determines a position of the geographic location with respect to the geographic area; and if the position of the geographic location with respect to the geographic area violates a rule, sends an alert.

In various embodiments, the system tracks a geographic location of a gang member wherein the tracking includes receiving an electronic signal from a tracking device associated with the gang member, the tracking device indicating the geographic location; determines a position of the geographic location with respect to the geographic area; and if the position of the geographic location with respect to the geographic area violates a rule, sends an alert.

In various embodiments, the system comprises a tracking device configured to receive signals and compute a present location of the tracking device; a component associate with the tracking device configured to transmit the computed location; and a monitoring center configured to receive the computed location, determine whether the present location violates a stored rule, and if the present location violates a stored rule, send an alert.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computing system for preventing gang-related activity, comprising:
receiving an indication of a correspondence between a person and a tracking device, the person being a known member of a gang;
receiving an indication of a correspondence between the gang member and a geographic area;
storing the received indications in a storage;
tracking a geographic location of the gang member wherein the tracking includes receiving an electronic signal from the tracking device indicating the geographic location;
determining a position of the geographic location with respect to the geographic area; and
if the position of the geographic location with respect to the geographic area violates a rule, sending an alert.

2. The method of claim 1 wherein the rule indicates that the geographic location cannot be within the geographic area.

3. The method of claim 1 wherein the rule indicates that the geographic location cannot be outside the geographic area.

4. The method of claim 1 further comprising sending the alert to a monitor.

5. The method of claim 1 further comprising displaying the geographic location on a map.

6. The method of claim 1 further comprising inferring the rule from a court order.

7. The method of claim 1 further comprising inferring the rule from a court injunction.

8. The method of claim 1 further comprising providing the geographic location of the gang member to a law enforcement officer.

9. A computer-readable medium storing computer-executable instructions that, when executed, cause a computing system to perform a method for preventing gang-related activity, the method comprising:
tracking a geographic location of a gang member wherein the tracking includes receiving an electronic signal from a tracking device associated with the gang member, the tracking device indicating the geographic location;
determining a position of the geographic location with respect to the geographic area; and
if the position of the geographic location with respect to the geographic area violates a rule, sending an alert.

10. The computer-readable medium of claim 9 wherein the method further comprises receiving status information from the tracking device.

11. The computer-readable medium of claim 10 wherein the status information identifies when a power supply associated with the tracking device was last charged.

12. The computer-readable medium of claim 11 further comprising sending an alert when the power supply has not been charged in violation of a rule.

13. The computer-readable medium of claim 10 wherein the status information identifies whether the tracking device has been tampered with.

14. The computer-readable medium of claim 9 further comprising sending the alert when the gang member has violated a time curfew.

15. A system for preventing gang-related activity, comprising:
a tracking device configured to receive signals and compute a present location of the tracking device;
a component associate with the tracking device configured to transmit the computed location;
a monitoring center configured to receive the computed location, determine whether the present location violates a stored rule, and if the present location violates a stored rule, send an alert.

16. The system of claim 15 further comprising a vehicle to which the tracking device is attached.

17. The system of claim 15 wherein the tracking device is affixed to a gang member.

18. The system of claim 15 wherein the monitoring center displays the present location on a map.

19. The system of claim 18 wherein the map is divided into zones wherein each zone is identified as corresponding to a gang.

20. The system of claim 18 wherein the a rule indicates to send an alert when the tracking device enters a zone.

21. The system of claim 18 wherein the a rule indicates to send an alert when the tracking device leaves a zone.
